(19) United States
(12) Patent Application Publication
(10) Pub. No.: US 2008/0098182 A1
(43) Pub. Date: Apr. 24, 2008

(54) APPARATUS FOR INFORMATION PROCESSING

(76) Inventor: Satoru Takashimizu, Yokosuka (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/753,010

(22) Filed: May 24, 2007

(30) Foreign Application Priority Data
Oct. 24, 2006 (JP) 2006-288197
Oct. 30, 2006 (JP) 2006-294700

(51) Int. Cl. G06F 12/00

(52) U.S. Cl. 711/154; 711/E12.001

(57) ABSTRACT

An information processing apparatus is disclosed, in which the bothersome user operation to retrieve and select the program to be deleted and compressed from a recording medium to acquire the available capacity of the recording medium can be omitted. The program of the recording medium to be deleted or compressed is selected according to a preset reference, a method of processing the selected program is selected, and the program and the processing method thus selected are output to the user.

### INCORPORATION BY REFERENCE

The present application claims priority from Japanese application P2006-288197 filed on Oct. 24, 2006, and P2006-294700 filed on Oct. 30, 2006, the content of which is hereby incorporated by reference into this application.

### BACKGROUND OF THE INVENTION

This invention relates to an information processing apparatus for recording program data.

The BS digital broadcast service using the broadcast earth satellite and the digital broadcast service using the terrestrial wave have recently begun. These digital broadcast services, which use video data, audio data and various types of data encoded (digitized) according to one standard, have the feature that the functions can be expanded using the digitized data by various methods. The conventional methods using this feature have been disclosed as described below.

JP-A-2002-271744 discloses an apparatus comprising a recording unit for recording the programs to be broadcast and a compression table containing, preset for each number of times of compression, the recompression conditions for compressing the program and the compression scheme used for the compression, wherein the activation is repeated in predetermined cycles to determine that those programs which are recorded in the recording unit and satisfy the recompression conditions for the next session are to be recompressed, whereby the program is recompressed to the level desired by the user at the time desired by the user.

JP-A-2004-328608, on the other hand, contains the description to the effect that “there are provided an information retrieving apparatus for retrieving the program candidates to be deleted to secure the available capacity so that the user can easily determine the programs to be deleted in the case where the recording medium is short of the available capacity and a recording and reproducing apparatus including the information retrieving apparatus”.

### SUMMARY OF THE INVENTION

In JP-A-2002-271744, in spite of the description therein that the user sets the desired time and the recompression conditions, the program to be recompressed is selected and the recompression process actually executed automatically without being recognized by the user, and therefore, the fact that the selection of each program to be recompressed and the processing result may not satisfy the user fails to be taken into consideration.

According to JP-A-2004-328608, on the other hand, the user is required to do the bothersome job of inputting the conditions for retrieving the program to be deleted and compressed. Also, in view of the fact that the available capacity of the recording medium is acquired at the time of recording reservation, the retrieval and selection of the program to be deleted and compressed are a troublesome job for the user who may be busy at the time of reservation.

In order to solve the aforementioned problems, according to this invention, the program to be processed is selected according to a preset reference while at the same time selecting a method for processing the selected program, and the program and the processing method thus selected are output to the user.

Specifically, the problems described above can be solved by the invention described in the appended claims.

According to this invention, there is provided a recording and reproducing apparatus for securing the available capacity while saving the labor of the user.

### BRIEF DESCRIPTION OF THE DRAWINGS

FIG. 1 is a diagram showing a configuration according to an embodiment of the invention.

FIG. 2 is a diagram showing an example of the signal input according to an embodiment of the invention.

FIG. 3 is a diagram showing an example of the signal processed according to an embodiment of the invention.

FIG. 4 is a diagram showing an example of the screen displayed according to an embodiment of the invention.

FIG. 5 is a diagram showing an example of the processing steps according to an embodiment of the invention.

FIG. 6 is a diagram showing an example of the processing steps according to an embodiment of the invention.

FIG. 7 is a diagram showing an example of the processing steps according to an embodiment of the invention.

FIG. 8 is a diagram showing an example of the screen displayed according to an embodiment of the invention.

FIG. 9 is a diagram showing an example of the screen displayed according to an embodiment of the invention.

FIG. 10 is a diagram showing a configuration according to an embodiment of the invention.

FIG. 11 is a diagram showing an example of the screen displayed according to an embodiment of the invention.

FIG. 12 is a diagram showing an example of the screen displayed according to an embodiment of the invention.

FIG. 13 is a diagram showing an example of the screen displayed according to an embodiment of the invention.

FIG. 14 is a diagram showing an example of the processing steps according to an embodiment of the invention.

FIG. 15 is a diagram showing an example of the processing steps according to an embodiment of the invention.

### DESCRIPTION OF THE EMBODIMENTS

Embodiments of the invention are described below with reference to the drawings. In the description that follows, the same reference numerals and characters designate the same component elements, respectively.

### Embodiment 1

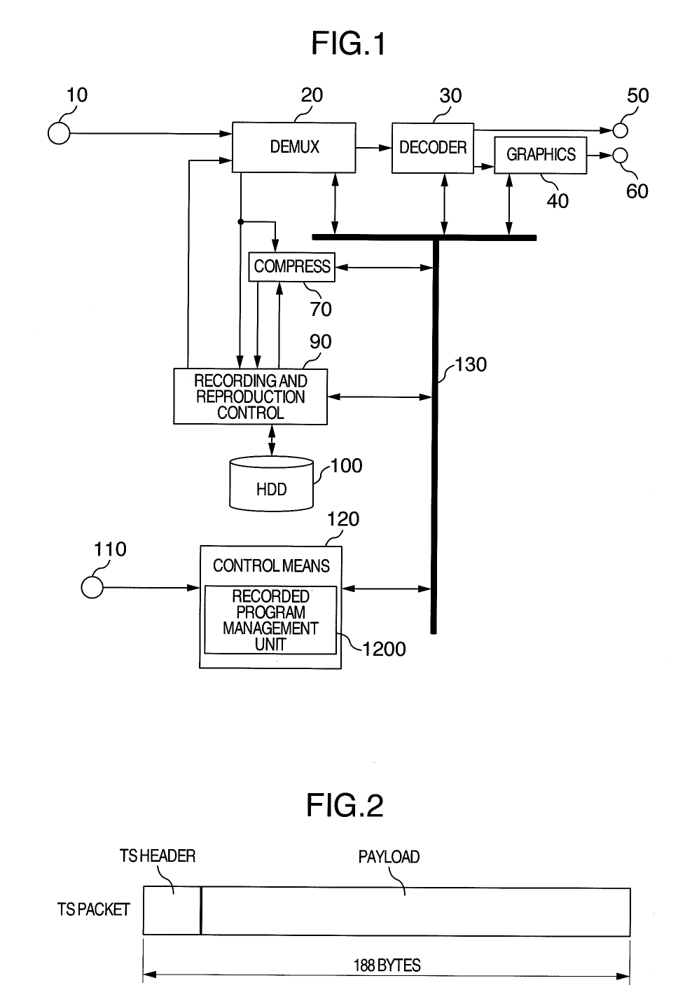

FIG. 1 is a diagram showing an example of the configuration of a recording and reproducing apparatus according to an embodiment of the invention. The description that follows assumes a recording and reproducing apparatus for viewing and recording the program input as a transport stream (TS), to which the apparatus configuration of the invention is not limited. Also, an explanation is given about the case in which the multiplex signal coded according to the MPEG (Moving Picture Experts Group) scheme is processed, and should not be interpreted to limit the signal to be processed to the MPEG signal.

Reference numeral 10 designates an input terminal of the transport stream. The transport stream according to this embodiment is configured of, for example, a plurality of 188-byte packets each including a TS header and a payload as shown in FIG. 2. Invalid data may be included between the packets.

Numeral 20 designates a demultiplexer (extractor). The transport stream reproduced is supplied to the demultiplexer 20, in which the coded video data, the coded audio data and other data for the program designated by a control unit 120 are extracted.

Numeral 100 designates a recording medium such as a hard disk drive for recording the program data, etc. According to this embodiment, the HDD 100 is employed as the recording medium. Nevertheless, any recording medium (such as a flash memory) other than the hard disk drive capable of recording the program data, etc. can be employed.

Numeral 30 designates a decoder. In the case where a program is viewed in real time, the coded video data and the coded audio data that have been extracted are supplied to and decoded in the decoder 30 thereby to output a video signal and an audio signal.

Numeral 40 designates a graphics processing unit supplied with the decoded video signal for multiplexing and outputting a graphics screen depending on the prevailing situation.

Numeral 50 designates a video output terminal for outputting the video signal, and numeral 60 an audio output terminal for outputting the audio signal. The output video signal of the graphics processing unit 40 and the output audio signal of the decoder 30 are output from the video output terminal 50 and the audio output terminal 60, respectively, and reproduced by a reproducing device not shown.

Numeral 110 designates an input terminal for inputting a command from the user, and numeral 120 a control unit operated by the control program stored in a memory not shown. The process described above is controlled by the command input through the command input terminal 110 and the control unit 120.

The command from the remote controller, etc. not shown, on the other hand, is input to the control unit 120 from the command input terminal 110, and in the case where the program designated by the command is recorded in the HDD 100, only the packets related to the program designated by the control unit 120 are extracted by the demultiplexer 20, which outputs by multiplexing the packets generated anew for reference at the time of reproduction from the HDD 100 or the packets prepared in advance.

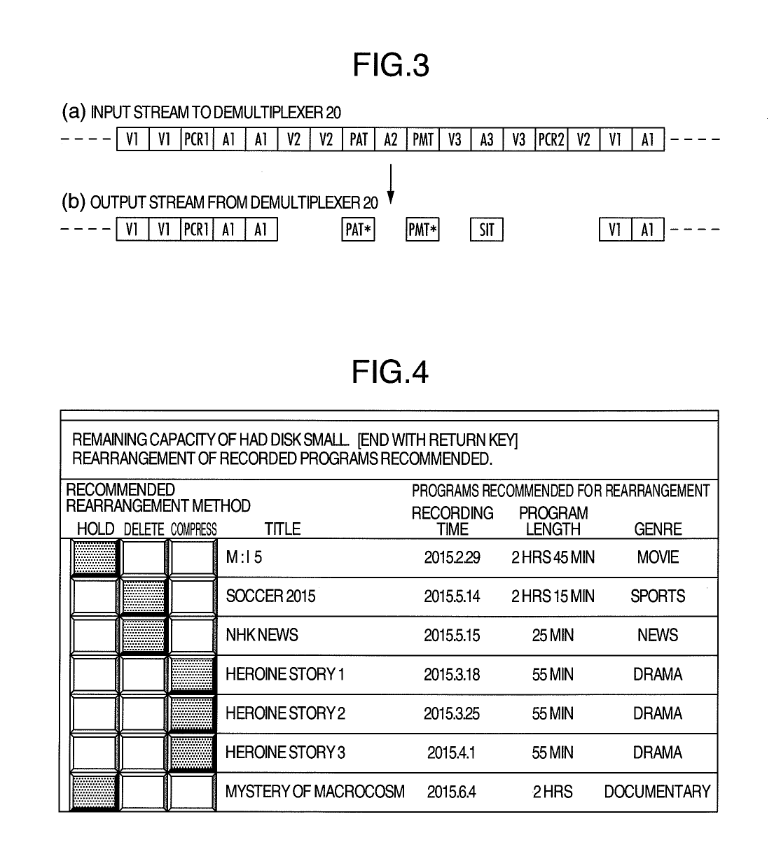

An example of the input and output transport streams, processed through the demultiplexer 20, of the program designated for recording is shown in FIG. 3.

In FIG. 3, assume that the program including the video data V1, the audio data A1 and the time information PCR (Program Clock Reference) designated as PCR1 is recorded. Though not shown in FIG. 3, the component elements of the program include the data broadcast, the packets for the particular data broadcast may also be recorded. The demultiplexer 20, under the control of the control unit 120, provisionally deletes the information packets such as PAT (Program Association Table) and PMT (Program Map Table) accessed at the time of reproduction. Thus, the PAT and PMT adapted for the stream multiplexed only with the program configured of the video data V1, the audio data A1 and the time information PCR1 are generated and multiplexed. Without multiplexing after deletion of PAT, PMT, the required data may be rewritten on the memory not shown.

Also, the program information such as the title of the program to be recorded is extracted, and based on the extracted program information, a SIT (Selection Information Table) is prepared and multiplexed. Reference characters V2, A2, V3, A3, which designate packets of the video and audio data of the programs not designated, are deleted as they are not required at the time of reproduction. From the input transport stream shown in FIG. 3(a), therefore, the output transport stream shown in FIG. 3(b) is obtained.

In the case where other information packets are contained which are desired at the time of reproduction, such information packets may also be extracted and output.

Numeral 70 designates a compressor for compressing the capacity of the program data, and numeral 90 a recording and reproduction control unit for executing the process required for recording. The output transport stream from the demultiplexer 20 is input to the compressor 70 and/or the recording and reproduction control unit 90.

The compressor 70 has the function of reducing the bit rate of the video stream, for example. Various methods are available to reduce the bit rate of the video stream. As an example, the MPEG2 video stream is transformed to the state of the DCT (Discrete Cosine Transfer) coefficient inversely, and after reducing the information amount by deleting the high frequency component which, if deleted, has only a small effect on the image quality or reducing the pixel information at appropriate intervals, transformed again into the MPEG2 stream. In another example, the video stream is decoded completely to reproduce the original video data provisionally, after which the bit rate is reduced by performing the operation of reducing the resolution by what is called the down-scaling and/or the operation of converting the video frame rate from 60 fps to 30 fps, and then the video stream is encoded again into the MPEG2 stream.

By executing the process described above, though the image quality is deteriorated, the capacity required to record the program in the HDD 100 can be advantageously reduced by reducing the bit rate.

The compressor 70 may convert the input stream into, for example, a stream of a different encoding format such as H.264 instead of reducing the bit rate in the MPEG2 format. The H.264 format has the advantage of producing the image quality equivalent to MPEG2 with a lower bit rate, and as compared with the case in which the bit rate is reduced in the form of MPEG2, can further reduce the bit rate.

The transport stream compressed in the compressor 70 is input to the recording and reproduction control unit 90. The recording and reproduction control unit 90 receives the output of the demultiplexer 20 or the output of the compressor 70 selectively based on the command input through the command input terminal 110 such as a remote controller not shown. The recording and reproduction control unit 90 executes the process required for recording such as the encryption for copyright protection on the input transport stream, and records the input transport stream as a program data in the HDD 100.

In the case where the recorded program is reproduced and viewed, the program data recorded in the HDD 100 is read by the recording and reproduction control unit 90 under the control of the control unit 120, and after executing the process of decryption, etc., output as a transport stream. The transport stream thus output is input to the demultiplexer 20, and the video and audio data are reproduced in similar manner as described above.

If required, the information packets multiplexed on the transport stream are accessed, and the graphics screen is superposed on the video data and displayed by the graphics unit 40.

Numeral 130 designates a bus such as the PCI (Peripheral Components Interconnect) bus.

The operation described above is controlled through the bus 130 by the command input from the operating unit such as a remote controller not shown through the input unit 110 and the control unit 120 operated in accordance with the program stored beforehand in a memory not shown.

Numeral 1200 designates a recorded program management unit for managing by acquiring the information on the recorded program such as the title of the program, the genre of the program, the date and hours recorded and the capacity of the recorded program, while at the same time managing the state such as the available capacity of the HDD 100.

In FIG. 1, the control unit 120 includes the recorded program management unit 1200. Further, the number of times and the frequency a recorded program is reproduced, and the title, the genre and the key words for the cast of the program recorded or reproduced, may be recorded and managed for each recorded program.

The information managed by the recorded program management unit 1200 is referred to as the program management information. By managing this information, the recorded program can be managed in fine detail. The program management information described above, though stored in the HDD 100 according to this embodiment, may alternatively be stored in a memory not shown.

The recorded program management unit 1200 checks the HDD 100 for the available capacity at predetermined time intervals or each time a program is recorded or otherwise predetermined conditions are established. Upon detection that the available capacity of the HDD 100 is reduced to less than a predetermined capacity, for example, 20% of the total capacity of the HDD 100, then the recorded program management unit 1200 reads the program management information stored in the HDD 100, and by selecting the programs meeting a predetermined standard and a method recommended for processing the programs recorded in the HDD 100, displays a menu screen as shown in FIG. 4.

In the display screen shown in FIG. 4, for example, three select buttons “hold”, “delete” and “compress” are displayed as a recommended program processing method on the one hand, and the title of each program, the date and hours the program is recorded, the length and genre of the program recommended for processing on the other hand. In the example of screen display shown in FIG. 4, the arrangement method is defined as a method of processing a program, and the arrangement program as a program processed. This is also the case with the embodiments described below.

In order to select any one of “hold”, “delete” and “compress” in the example of the display screen shown in FIG. 4, the button indicating the desired method is selected using, for example, the cursor key and the enter key of the remote controller not shown and the process is thus determined.

In the example of the display screen shown in FIG. 4, assuming that the user selects and determines “hold” from the operating unit such as the remote controller not shown, the control unit 120 removes the designated program from the process and executes no process thereon.

In similar fashion, assuming that “delete” is selected and determined, the information on the program for which “delete” was designated is deleted from the program management information. In the process, the program data is not actually deleted from the HDD 100, but only the information on the designated program is deleted from the program management information. In this way, the processing time can be shortened. As a result, the available capacity of the HDD 100 is increased by the deleted amount within a short time.

In the case where “compress” is selectively determined, on the other hand, the program data designated by the recording and reproduction control unit 90 is read from the HDD 100 in accordance with the command of the control unit 120, and after executing the process of decryption or the like, output as a transport stream and input to the compressor 70. The compressor 70 outputs the input transport stream after executing the process for reducing the bit rate thereof as described above. The transport stream output from the compressor 70 is input to the recording and reproduction control unit 90. The recording and reproduction control unit 90 encrypts the input transport stream and records it in the HDD 100. Once all the data on the designated program are compressed and completely recorded in the HDD 100, the control unit 120 controls the recording and reproduction control unit 90 to delete the program data before “compress” from the HDD 100. As a result, the capacity of the HDD 100 occupied by the same program data can be reduced to about one half, for example, and the available capacity of the HDD 100 can be increased.

The foregoing description deals with a case in which the original data of the program is deleted after all the data of the program are completely compressed. Nevertheless, the deletion is not limited to such a method. Each time a predetermined amount of data is compressed at one minute intervals, for example, the compressed data portions of the original program may be deleted. This method, though required to be controlled more frequently by the control unit 120, can increase the available capacity of the HDD 100 even during the compression process.

The “delete” or “compress” process described above may be executed immediately after designation by the user or while no recording or the like operation is going on at a later time. The “delete” process, for example, is simply to delete the information on the designated program from the program management information managed by the recording information management unit 1200, and therefore, completed within a very short time. As far as “delete” is concerned, therefore, the process may be executed immediately after designation without any appreciable trouble.

The “compress” process, on the other hand, is time consuming, and therefore, can be executed while the apparatus is not occupied by the recording process or the like to avoid the inconvenience which otherwise might be felt by the user incapable of performing the desired operation. In this case, a message on the timing of processing such as “Process executed from 2:00 A.M.” is displayed, so that the user can change the scheduled timing if inconvenient for him/her. Also, after the process, the user may display a message such as “The process is over” at the timing of starting (such as switching on the power) to use the recording device.

As indicated by the example of the display screen shown in FIG. 4, the description such as “End with return key” may be displayed as a method of erasing the displayed screen of FIG. 4 and returning to the normal TV display screen in accordance with a command from the operating device such as a remote controller. As a result, the user can restore the normal TV viewing mode whenever desired by a simple operation.

In connection with the foregoing description, various methods are conceivable for the recording program management unit 1200 to select the program recommended for processing and/or the processing method.

The information such as “whether the predetermined time has elapsed from the recording”, “whether the program is included in a genre specified in advance”, “how many times the user has reproduced the program”, “whether the key word designated by the user is included”, “whether the propensity information such as the genre and the key word extracted from the program-related information such as the program title and the cast according to a preset standard are included” or “to what degree the available capacity of the HDD 100 is reduced from a predetermined capacity” are determined and selected individually or in combination.

For example, a sport program on a competition or a news program which is recorded more than one month in the past and whose result is known is not worthy of viewing later, and therefore, recommended as a program to be “deleted”. In the case where the user sets “movie” as a genre to his/her liking in advance, on the other hand, it can be determined as worthy of viewing later, and therefore, the movie particular program is recommended as a program to be “held”. Also, a serial drama or the like never viewed since the recording thereof is recommended as a program to be “compressed”. A serial drama has a series of stories, and if even a day's section is deleted, the viewing of subsequent broadcast sections may be adversely affected, and therefore, the data is desirably held in a reduced amount by compression. The determination whether a given program is a news, a movie or a serial drama is made by the control unit 120 either based on the extracted program-related information or the information such as whether the program is broadcast at a predetermined time every week.

Further, the control unit 120, by extracting the key word from a program viewed by the user, may identify the genre of the program viewed at a predetermined frequency or higher and the program including the extracted key word may be “held” or “compressed”.

As an alternative, the user himself/herself can designate the future processing method at the time of viewing or reserving a specified program or a specified serial program. As a result, the program recommended for processing can be selected.

Also, the available capacity of the HDD 100 may be used as a standard for the recording program management unit 1200 to select the program recommended for processing. According to one such method, in the case where the available capacity of the HDD 100 is reduced below a predetermined level, a program recommended for processing and/or a processing method is presented to the user by indicating the degree to which the available capacity is reduced from a predetermined level. Specifically, the program recommended for processing and/or the processing method is selected based on the difference between a predetermined capacity and the available capacity of the HDD 100.

For this purpose, the recording program management unit 1200 selects a program recommended for processing and/or the processing method in such a manner that the available capacity of the HDD 100 is increased beyond a predetermined level by the processing.

In the case where the predetermined capacity is 20% of the total capacity of the HDD 100, for example, assume that the available capacity of the HDD is 18% of the total capacity of the HDD 100. Then, the process is executed to increase the available capacity by at least the difference of 2%. Therefore, the recording program management unit 1200 selects a program having a short recording time as a program recommended for processing and recommends “compress” as a processing method.

Similarly, in the case where the predetermined capacity is 20% of the total capacity of the HDD 100 and the remaining capacity of the HDD is 3% of the total capacity of the HDD 100, then the execution of the process is required to increase the available capacity by the difference of at least 17% of the total capacity of the HDD 100. Therefore, the recording program management unit 1200 selects a program having a long recording time as a program recommended for processing and recommends “delete” as a processing method.

As an alternative, the processing method is fixed to “delete”, and the program recommended for processing is selected in accordance with the degree to which the remaining capacity of the HDD 100 is reduced below a predetermined capacity. Specifically, the program recommended for processing is selected based on the difference between a predetermined capacity and the available capacity of the HDD 100.

In the case where the predetermined capacity is 20% of the total capacity of the HDD 100 and the remaining capacity of the HDD is 12% of the total capacity of the HDD 100, for example, then one or a plurality of program data having the combined capacity of not less than the difference of 8% of the total capacity of the HD 100 are selected and displayed as a program recommended for deletion. The program recommended for deletion is selected based on the time passed from the recording in the HDD 100, the preset propensities of the user, the past history of viewing the program, etc.

As still another alternative, with the processing method fixed to “compress”, the program recommended for processing is selected in accordance with the degree to which the remaining capacity of the HDD 100 is reduced below a predetermined capacity. Specifically, the program recommended for processing is selected based on the difference between a predetermined capacity and the available capacity of the HDD 100.

In the case where the predetermined capacity is 20% of the total capacity of the HDD 100 and the remaining capacity is 16% of the total capacity of the HDD 100, for example, then the program data adapted to be compressed and decrease the capacity by at least 4% of the combined capacity of the HDD 100 constituting the difference, or a plurality of program data with the combined capacity thereof adapted to be decreased by at least 4% of the total capacity of the HDD 100 by compression are selected and displayed as programs recommended for compression.

As in the case where the processing method is fixed to “delete”, the program recommended for compression may be selected based on the time passed from the recording in the HDD 100, the propensities of the user and the past history of viewing the program.

As a further alternative, the program to be processes is fixed, and the processing method is selected in accordance with the degree to which the remaining capacity of the HDD 100 is decreased below the predetermined capacity. Specifically, the processing method is determined based on the difference between the predetermined capacity and the available capacity of the HDD 100.

The candidates for the program to be process is selected, for example, in accordance with whether the predetermined time has passed after recording, whether the program is of a specific genre designated in advance, how many times the user has reproduced the program or whether the key word designated by the user is included or not.

The processing method may be selected in such a manner as to increase the remaining capacity of the HDD 100 beyond a predetermined capacity by calculating the degree to which the capacity that can be reduced by compression or the degree to which the capacity can be reduced in total by deletion of the selected candidate for the program to be processed.

An explanation was given above about the technique for selecting the program recommended for processing and/or the processing method according to the degree to which the remaining capacity of the HDD 100 is reduced below a predetermined level. Nevertheless, a similar effect can be achieved by selecting the program recommended for processing according to the degree to which the recording capacity of the HDD 100 has increased beyond a predetermined level. Specifically, a similar effect can be produced by a configuration in which the predetermined capacity is not the available capacity but the recording capacity, and the program recommended for processing and/or the processing method is selected based on the difference between the recording capacity of the HDD and the predetermined recording capacity.

Alternatively, instead of the difference between the predetermined capacity and the available capacity of the HDD 100, a predetermined ratio of the available capacity of the HD 100 to a predetermined capacity may be used. The aforementioned embodiment deals with a case in which the candidate for processing is selected mainly based on the difference between the predetermined capacity and the available capacity of the HDD 100. The invention, however, is not limited to such a difference but may use the comparison between the predetermined capacity and the available capacity of the HDD 100 with equal effect.

Also, the programs meeting these conditions may be displayed in a limited number accommodable on one screen. Those of the limited number of the programs meeting the aforementioned conditions may be determined and displayed, for example, which have the longest time elapsed from the recording, the least number of times viewed, the degree of coincidence between the key word designated by the user and the key word extracted by the control unit 120 from the program-related information and/or the degree to which the remaining capacity of the HDD 100 is reduced below a predetermined capacity.

By limiting the programs recommended for processing to the number that can be displayed in one screen, the number of the programs processed at a time can be reduced and the operation labor saved as compared with the case in which a multiplicity of programs are displayed over a plurality of screens.

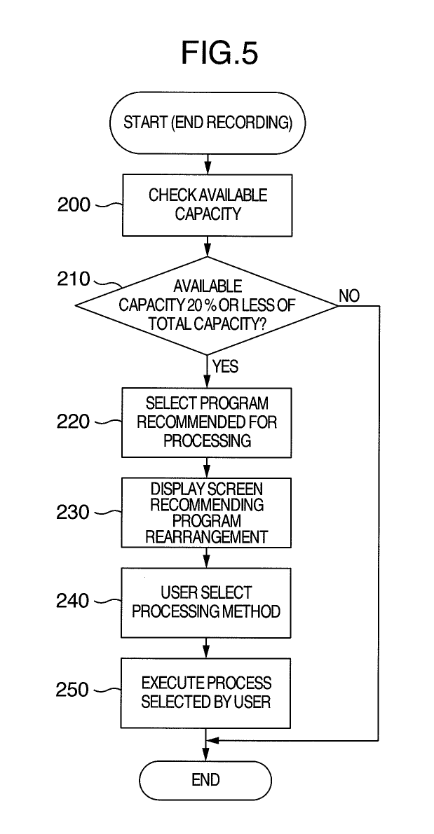

The aforementioned process can be executed following, for example, the steps shown in FIG. 5. The process of the steps shown in FIG. 5 is started at the end of the recording operation directly designated by the user through the operating unit such as a remote controller.

Upon complete recording, the available capacity of the HDD 100 is checked in step 200.

Step 210 determines whether the available capacity checked is not more than, for example, 20% of the total capacity. In the case where the available capacity is not less than 20% of the total capacity, the process is ended without being executed further. In the case where the available capacity is not more than 20%, on the other hand, the process proceeds to step 220.

Although this embodiment is configured to determine whether the available capacity is not more than 20% of the total capacity or not, this is only an example, and the reference capacity ratio may be changed appropriately.

Unlike this embodiment in which the available capacity ratio is used as a reference, the actual capacity value (such as “not more than 50 Gbytes in total available capacity”) may alternatively be used instead of the ratio as a reference.

Also, instead of the available capacity ratio used in this embodiment, the recording capacity ratio (such as “the recording capacity of not less than 80% of the total capacity”) or the actual value of the recording capacity (such as “not less than 450 Gbytes in recording capacity”) may be used as a reference.

In the embodiments described below, the execution of the process may be determined based on whether the available capacity is not more than 20% of the total capacity or not. As in the aforementioned cases, however, this reference may be changed appropriately.

In step 220, the program recommended for processing such as “hold”, “delete” or “compress” is selected in accordance with a reference such as the time elapsed from the recording, a specific genre designated in advance, the number of times the program is reproduced by the user, the key word designated by the user, the propensity information such as the key word or the genre extracted from the program-related information including the program title and the cast and the available capacity of the HDD 100.

The information on the program selected in step 220 is displayed in step 230, and the process selected by the user in step 240.

The process selected by the user is executed in step 250, whereby the available capacity of the HDD 100 can be secured.

With regard to the reference for selecting the program recommended for executing the process, assuming that the capacity preset for starting the process is a first set capacity, a second set capacity may additionally be preset as a capacity after processing.

For example, the first set capacity is assumed to be 20% of the total capacity of the HDD 100, and the second set capacity 30% of the total capacity of the HDD 100. Specifically, the process is stated once the available capacity of the HDD 100 is reduced below the first set capacity, i.e. once the available capacity of the HDD 100 is reduced below 20% of the total capacity. This process is executed based on the second set capacity as a reference in such a manner that the available capacity of the HDD 100 reaches at least 30% of the total capacity thereof.

In the absence of the second set capacity, assume that the process is executed in such a manner that the remaining capacity of the HDD 100 increases slightly beyond the first set capacity. Then, the available capacity of the HDD 100 would be reduced below the first set capacity soon thereafter, resulting in a shorter time before repeated execution of the process.

The process is required to be executed less frequently, however, by the configuration in which the second set capacity is determined, and in the case where the available capacity of the HDD 100 is reduced below the first set capacity, the process is executed in such a manner that the available capacity of the HDD 100 increases beyond the level of the second set capacity.

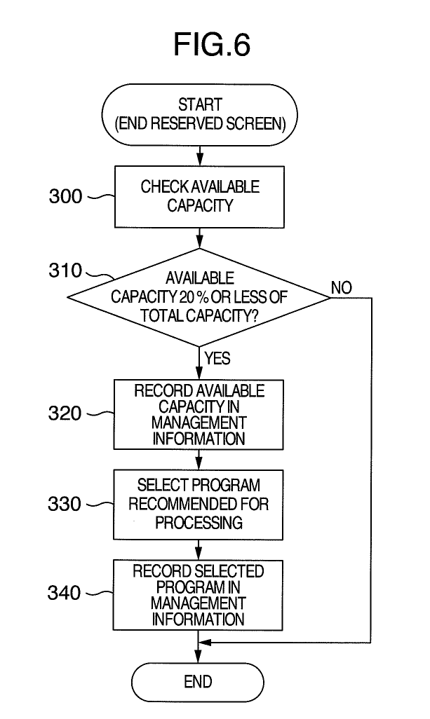

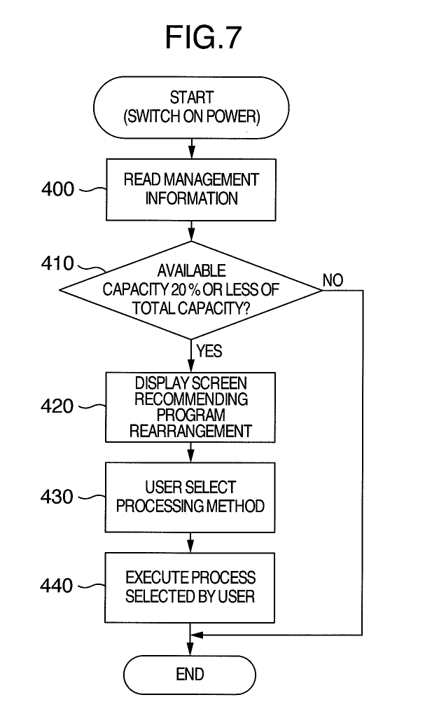

The description with reference to FIG. 5 deals with the processing steps starting with the time point of ending the video recording directly designated by the user by way of the operating unit such as a remote controller. In the case where a program is recorded by reservation, however, the process is executed by steps different from FIG. 5 such as shown in FIGS. 6 and 7.

In FIG. 6, the available capacity of the HDD 100 is checked in step 300 after completing the reserved recording.

The available capacity thus checked is determined in step 310, and if it is not less than 20% of the capacity of the HDD 100, for example, the process is ended there.

In the case where the available capacity is not more than 20%, on the other hand, the process proceeds to step 320, in which the available capacity is recorded in the program management information.

In the next step 330, a program recommended for processing is selected in accordance with a preset reference as in step 220.

The program selected in step 330 is recorded as program management information in the HDD 100. Upon complete execution of the process up to step 340, the operation related to the reservation is ended, and by finally switching off the power supply, the process is finished.

The subsequent operation is performed in accordance with the steps shown in FIG. 7. Once the power supply of the recording and reproducing apparatus is switched on by the user, the program management information is read from the HDD 100 by the recording program management unit 1200 in step 400.

The program management information thus read is checked in step 410, thereby confirming whether the available capacity is not more than 20% of the total capacity of the HDD 100. In the case where the available capacity is not less than 20% of the total capacity of the HDD 100, the process is ended. In the case where the available capacity is not more than 20% of the total capacity of the HDD 100, on the other hand, the process proceeds to step 420.

The steps explained with reference to FIG. 7 represent the process executed at the time of switching on the power supply first after the end of the reserved recording in FIG. 6. The program recommended for processing in step 330 shown in FIG. 6, therefore, is already selected, and the program selected is recorded in the program management information in step 340. In step 420, the information on the program recorded in the recording management information selected in step 340 are read and the screen is displayed for recommending the rearrangement of the information thus read.

In step 430, the processing method is selected and determined by the user based on the displayed screen, and the process selected by the user is executed in step 440.

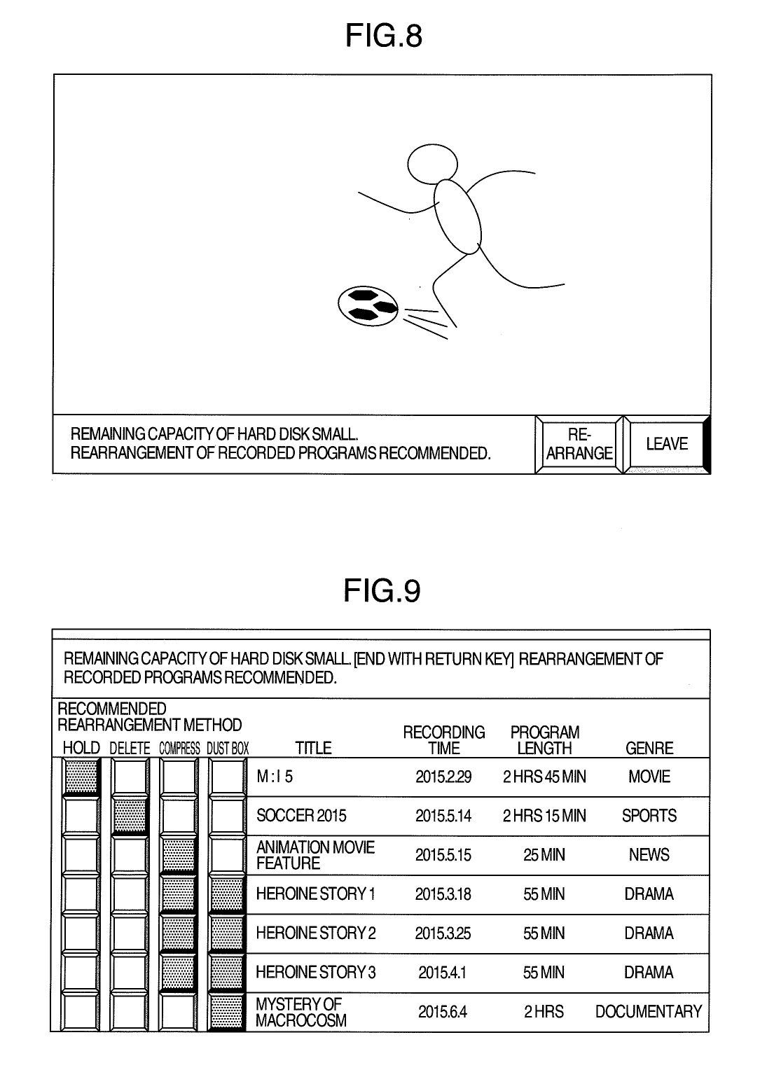

The display screen in FIG. 4 represents a case in which the screen seeking the selection by the user is displayed immediately after the available capacity of the HDD 100 is reduced below the preset capacity. As an alternative, the screen as shown in FIG. 8 may be displayed first requesting the user to determine whether the information is to be rearranged or not. As a result, the user can determine whether the rearrangement is required or not as the occasion demands.

Also, the description with reference to FIG. 4 represents a case where the three processing methods including “hold”, “delete” and “compress” are presented. Instead of the above, still another processing method can be presented as shown in FIG. 9.

FIG. 9 shows a case in which the choice called “trush box” is presented. As a process executed in the case where “trush box” is selected, the designated program is executed from the HDD 100 in the absence of a command before a predetermined time passes.

As an alternative, a configuration may be employed in which the program designated for “trush box” may be deleted in the absence of a command before the lapse of a predetermined time from the compression.

As another alternative, a configuration may be employed in which the user may select and preset the processing method assigned to “trush box” from a plurality of the processing methods described above.

Also, a configuration may be employed in which in the case where “trush box” is selected, the process may be canceled within a predetermined time and a different process may be selected.

By doing so, the user can be advantageously given the chance of rethinking the contents of the process.

As explained above, according to this embodiment, the user can be notified of the requirement of processing the recorded program before the recordable capacity of the HDD 100 is reduced extremely or the available capacity is inconveniently lost in its entirety.

Also, the labor of the user to select the candidates for the recording programs to be processed or the processing method can be saved, and the processing method can be determined satisfactorily by the user. Thus, the labor of the user operation is reduced and the available capacity of the HDD 100 can be secured in a way satisfactory to the user.

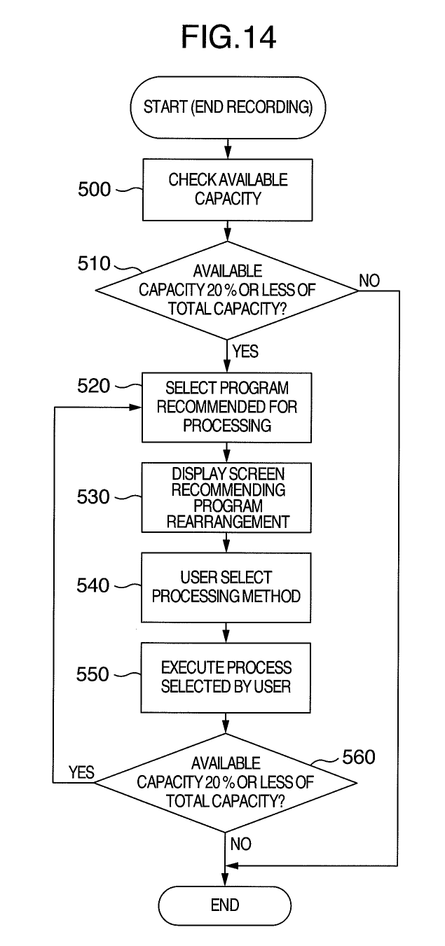

FIG. 14 is a flowchart including the step (S560) of confirming the total available capacity again after executing the process selected by the user in step 250 in the flowchart of FIG. 5. The steps S500, S510, S520, S530, S540, S550 in FIG. 14 are identical with the steps S200, S210, S220, S230, S240, S250, respectively, in FIG. 5.

Depending on the processing method selected by the user in step S540, the available capacity of the HDD 100 may still remain not more than 20% of the total capacity. The available capacity of the HDD 100 is confirmed again in step S560, therefore, and if the available capacity exceeds 20% of the total capacity, the process is ended, while if it is not more than 20%, the process is returned to step S520 and executed again. With this configuration, the available capacity of the HDD 100 can be secured more positively.

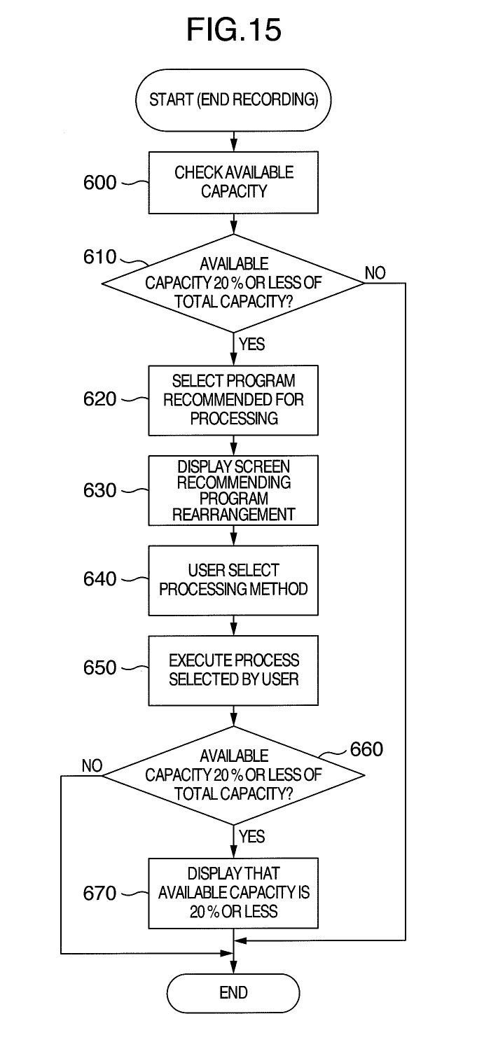

FIG. 15 shows the flowchart of FIG. 14 additionally including the step (S670) wherein in the case where the available capacity of the HDD 100 is not more than 20% of the total capacity in step S560 in the flowchart of FIG. 14, the fact is displayed and the process ended.

Steps S600, S610, S620, S630, S640, S650, S660 in FIG. 15 are identical with steps S500, S510, S520, S530, S540, S550, S560, respectively, in FIG. 14.

Some user may be not desirous of the process for the reason that he/she desires to hold all the programs or is satisfied that the available capacity of the HDD 100 is not more than 20% of the total capacity since the recording of only a short program is planned. In such a case, the process may be required to be ended with the display to the effect that the available capacity of the HDD 100 is not more than 20% of the total capacity.

Steps S560, S660, S670, which are added to step S250 shown in the flowchart of FIG. 5 as described above, may alternatively be added after the step (S440) of executing the process selected by the user in the flowchart of FIG. 7.

### Embodiment 2

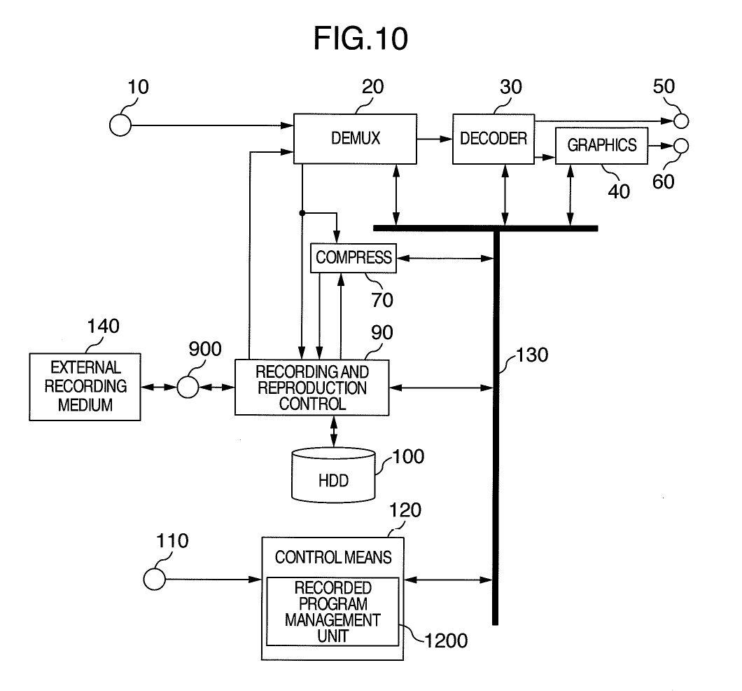

FIG. 10 shows a configuration of another embodiment of the invention. In FIG. 10, numeral 140 designates an external storage medium including a HDD device, a magnetooptic recording medium or a nonvolatile memory configured as a removable unit, which is connected to the recording and reproduction control unit 90 through the input/output unit 900. As compared with FIG. 1, the external recording medium 140 and the input/output unit 900 interposed between the external recording medium 140 and the recording and reproduction control unit 90 are newly added.

The transport stream of the input program can be recorded in the external storage medium 140 like in the HDD 100. Also, the program already recorded in the HDD 100 can be moved to the external storage medium 140.

The operation of recording the program input as a transport stream directly in the external storage medium 140 is explained below.

As explained above, the recording and reproduction control unit 90 receives selectively one of the output of the demultiplexer 20 and the output of the compressor 70 based on a command input through the command input terminal 110 from a remote controller or the like not shown.

Assume that the user inputs, by way of the input unit 110 using the operating unit such as a remote controller not shown, a command to record the program in the external storage medium 140. The control unit 120, in accordance with the input command, controls the recording and reproduction unit 90 and encrypts the input transport stream or otherwise executes the process similar to the one described above, and outputs and records the result to and in the external storage medium 140 through the input/output unit 900.

In reproducing the program recorded in the external storage medium 140, assume that the user inputs a command for reproduction from the external storage medium 140 by way of the input unit 110 using the operating unit such as a remote controller not shown. The control unit 120, in accordance with the input command, controls the recording and reproduction control unit 90 and reads the recorded program from the external storage medium 140. The subsequent operation for viewing this program is similar to the operation of viewing the program reproduced from the HDD 100 described in the method of the first embodiment.

The operation of moving the program recorded in the HDD 100 to the external storage medium 140 is explained below. Assume that the user inputs a command for moving the program from the HDD 100 to the external storage medium 140 by way of the input unit 110 using an operating unit such as a remote controller not shown. The control unit 120, in accordance with the input command, controls the recording and reproduction control unit 90 and reads the designated program data from the HDD 100.

The program data thus read is output to the external storage medium 140 through the input/output unit 900, and recorded in the external storage medium 140. Once the recording is complete or a predetermined amount of data are read from the HDD 100 and recorded in the external storage medium 140, then the data read from the HDD 100 is deleted.

In this way, all the data of the designated program are recorded in the external storage medium 140, while at the same time moving by deleting the data read from the HDD 100. As a result, the recordable capacity of the HDD 100 can be increased on the one hand, and the program recorded can be held in the external storage medium 140 on the other hand.

In the aforementioned case, the program data read from the HDD 100 is encrypted. As long as the program data is simply moved and not viewed, however, the encrypted program data can be recorded as it is in the external storage medium 140 and not required to be decrypted or otherwise processed. Thus, the process can be advantageously simplified.

In the configuration of FIG. 10, the program data read from the HDD 100 may be compressed and held in the external storage medium 140. This operation is explained below.

Assume that the user inputs, from the input unit 110 by way of the operating unit such as a remote controller not shown, a command to compress by reproducing the program from the HDD 100 and move the program to the external storage medium 140. In accordance with the input command, the control unit 120 controls the recording and reproduction unit 90 and reads the designated program data from the HDD 100.

The program data thus read, after being decrypted or otherwise processed in the recording and reproduction control unit 90, is output as a transport stream and input to the compressor 70. The transport stream input to the compressor 70 is compressed and the bit rate thereof reduced. Thus, the transport stream reduced in capacity as required for recording is output. The transport stream thus output is input to the recording and reproduction control unit 90.

The recording and reproduction control unit 90 encrypts or otherwise processes the input transport stream as described above, and outputs the processing result to the external storage medium 140 through the input/output unit 900.

As a result, the program thus far recorded in the HDD 100 can be compressed and recorded in the external storage medium 140. In the case where the recording is complete or a predetermined amount of data are read from the HDD 100 and moved to the external storage medium 140, the data read from the HDD 100 is deleted.

In this way, all the data of the designated program are recorded in the external storage medium 140 and the data read from the HDD 100 are deleted. Thus, the program data can be compressed and moved.

As a result, the recordable capacity of the HDD 100 can be increased on the one hand, and the recorded program smaller in capacity can be held in the external storage medium 140 on the other hand.

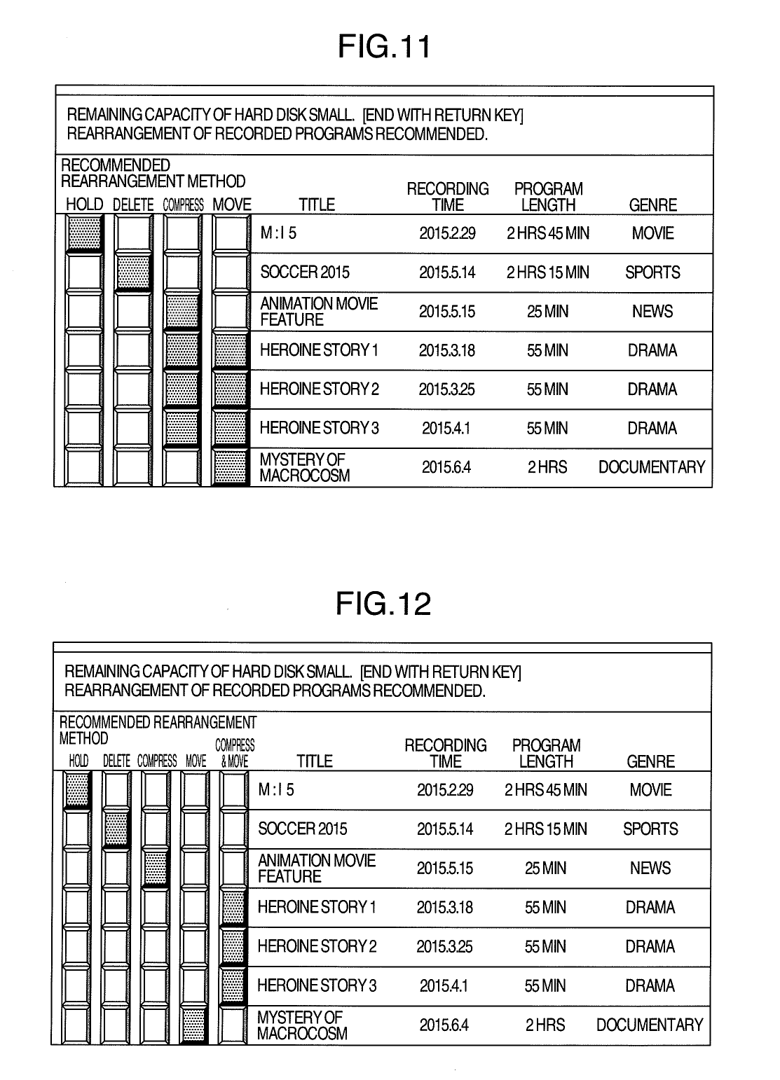

FIG. 11 shows an example of the operation menu screen by which the program movement described above can be selected by the user. The difference from the example of the display screen shown in FIG. 4 lies in that the “move” button is additionally displayed.

On the display screen example of FIG. 11, assume that the “move” button is selectively determined by the operating unit such as a remote controller not shown. The operation described above is performed, and the program recorded in the HDD 100 is moved to the external storage medium 140.

Also, in the case where “compress” and “move” are selectively determined at the same time, the program recorded in the HDD 100 is compressed while being moved to the external storage medium 140. Although the example of the display screen shown in FIG. 11 represents a case in which the operations of “compress” and “move” are performed by selecting and determining two buttons at the same time, an operating button “compress and move” may be displayed independently as in the example of the display screen shown in FIG. 12.

In this case, the number of buttons displayed is increased as compared with the example of the display screen shown in FIG. 6. The advantage, however, is that the operation can be understood simply by viewing the display screen without referring to the operation manual or the like beforehand.

As still another choice, a configuration can be employed in which the program data can be moved to the external storage medium 140 while leaving in the HDD 100 only a favorite scene designated by the user from the input unit 110 through the operating unit such as a remote controller not shown.

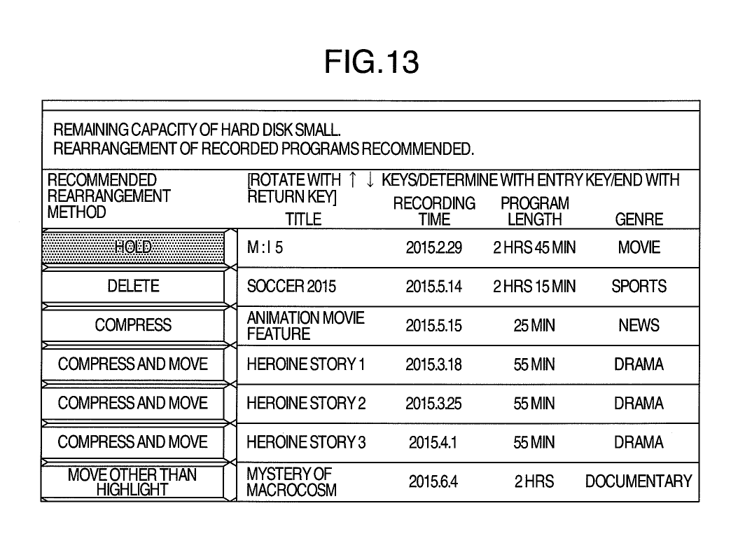

An example of this choice is shown in FIG. 13. In FIG. 13, upon selective determination of “move other than highlight”, only the data for the favorite portion designated in advance is left in the HDD 100, while the whole program data including the remaining portion are moved to the external storage medium 140.

The example of the display screen shown in FIG. 13 involves an increased number of choices. Therefore, each choice is not assigned to a button, but the contents of a choice displayed in one button are switched by use of the operating unit such as a remote controller.

Though not shown, the aforementioned choices may be combined. For example, only the favorite scene for the user is left in the HDD 100, while the whole program including the favorite scene may be compressed and moved to the external storage medium 140.

As a result, the available capacity of the HDD 100 can be secured while at the same time making it possible to confirm the kind of the programs recorded in the past without connecting the external storage medium 140. Also, the program data with a decreased data capacity can be held in the external storage medium 140.

Although the foregoing description assumes that the favorite scene is designated by the user, the control unit 120, for example, may automatically designate the scene to be left in the HDD 100.

In this case, the recording program management unit 1200 has the function of extracting the unique portions such as big image movement or high sound level of the recording program, and leaving only the extracted portions in the HDD 100. This configuration can advantageously save the labor of the user to designate the favorite scene.

The process such as “move” or “compress & move” described above, like the process “compress” explained with reference to FIGS. 1 an 4, may be executed by the user not immediately after designation of the process but during the unbusy hours when the recording process is not executed. As a result, the designated process can be efficiently executed without interfering with the user operation.

The embodiments described above represent a case in which the program data are held, the data thus held are not limited to the program data. This invention is also applicable to, for example, music data, movie data and any other data that can be recorded in the HDD 100.

It should be further understood by those skilled in the art that although the foregoing description has been made on embodiments of the invention, the invention is not limited thereto and various changes and modifications may be made without departing from the spirit of the invention and the scope of the appended claims.

1. An information processing apparatus comprising:
an input unit for inputting data;
a storage unit for storing the input data; and
a data management unit for managing the data stored in the storage unit;
wherein the data management unit outputs the data stored in the storage unit and the candidate for the method of processing the data to the user based on a preset reference.

2. The information processing apparatus according to claim 1,
wherein the data management unit determines and outputs to the user the candidate for the data to be processed from the data stored in the storage unit and the candidate for the data processing method in the case where the available capacity of the storage unit is reduced below a preset capacity.

3. The information processing apparatus according to claim 1,
wherein the reference is preset based on the available capacity of the storage unit.

4. The information processing apparatus according to claim 1,
wherein the data management unit determines and outputs to the user the candidate for the data to be processed from the data stored in the storage unit and the candidate for the data processing method based on the comparison between the available capacity of the storage unit and the preset capacity in the case where the available capacity of the storage unit is reduced below a preset capacity.

5. The information processing apparatus according to claim 4,
wherein the data management unit determines the candidate for the data to be processed and the candidate for the data processing method in such a manner that the available capacity of the storage unit is increased beyond the preset capacity.

6. The information processing apparatus according to claim 4,
wherein the candidate for the processing method includes compression and deletion.

7. The information processing apparatus according to claim 4,
wherein the data management unit determines the candidate for the data to be compressed or deleted from the data stored in the storage unit in such a manner that the available capacity of the storage unit is increased beyond the preset capacity.

8. An information processing apparatus comprising:
an input unit for inputting a program data;
a program holding unit for holding the program data input from the input unit; and
a hold program management unit for managing the program data held;
wherein in the case where the available capacity of the program holding unit is reduced below a preset capacity, the hold program management unit selects the program data held in the program holding unit and/or a program data processing method from a plurality of processing methods based on the comparison between the available capacity of the program holding unit and the preset capacity and outputs the result of selection to the user.

9. The information processing apparatus according to claim 8,
wherein in the case where the available capacity of the program holding unit is reduced below the preset capacity, the hold program management unit selects the program data held in the program holding unit based on the comparison between the available capacity of the program holding unit and the preset capacity, selects the processing method of the selected program data from the plurality of the processing methods, and outputs the selected program and the selected program processing method to the user.

10. The information processing apparatus according to claim 8,
wherein the candidates for the processing method of the program held in the program holding unit and output to the user include at least two of the operation items of the program data deletion, the program data bit rate conversion and the program data encoding scheme conversion.

11. The information processing apparatus according to claim 1,
wherein the candidates for the processing method are in not more than a predetermined number of programs.

12. An information processing method comprising the steps of:
receiving data;
storing the received data; and
outputting at least one of the data stored and a candidate for the method of processing the stored data to the user based on a preset reference.

13. The information processing method according to claim 12,
wherein the preset reference is set based on the remaining capacity available for storage.

14. The information processing method according to claim 12,
wherein the candidate for the data to be processed from the stored data and/or the candidate for the method of processing the data is determined and output to the user in the case where the remaining capacity available for storage is reduced below a preset capacity.

15. The information processing method according to claim 12,
wherein the candidate for the data to be processed from the stored data and/or the candidate for the method of processing the data is determined based on the comparison between the remaining capacity available for storage and the preset capacity in the case where the remaining capacity available for storage is reduced below the preset capacity.

16. The information processing method according to claim 15,
wherein the candidate for the data to be processed from the stored data and/or the candidate for the method of processing the data is determined in such a manner that the remaining capacity available for storage increases beyond the preset capacity.

17. The information processing method according to claim 15,
wherein the candidate for the processing method includes compression and deletion.

18. The information processing method according to claim 15,
wherein the candidate for the data to be compressed or deleted is determined from the stored data in such a manner that the capacity available for storage increases beyond the preset capacity.
